(19) United States
(12) Patent Application Publication
(10) Pub. No.: US 2008/0088778 A1
(43) Pub. Date: Apr. 17, 2008

(54) Transflective liquid crystal display with transflective film in color filter substrate assembly thereof

(75) Inventors: Li-Juan Huang, Shenzhen (CN); Wei Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/974,785

(22) Filed: Oct. 16, 2007

(30) Foreign Application Priority Data
Oct. 16, 2006 (TW) 95138074

(51) Int. Cl. G02F 1/1335

(52) U.S. Cl. 349/114

(57) ABSTRACT

An exemplary transflective liquid crystal display 1 includes a thin film transistor (TFT) substrate assembly 11, a color filter substrate assembly 12 parallel to the TFT substrate assembly 11, a liquid crystal layer 13 sandwiched between the TFT substrate assembly 11 and the color filter substrate assembly 12, and a backlight module 14 configured to provide light beams which transmit through the color filter substrate assembly, the liquid crystal layer, and the TFT substrate assembly. The color filter substrate assembly includes a transparent substrate 121, a transflective film 122, and a color filter 123. The transflective film is formed at an inner surface of the transparent substrate. The color filter is formed at an inner surface of the transflective film.

### FIELD OF THE INVENTION

The present invention relates to liquid crystal displays (LCDs), and particularly to a transflective liquid crystal display that includes a color filter substrate assembly having a transflective film.

### BACKGROUND

LCD devices have the advantages of portability, low power consumption, and low radiation, and have been widely used in various portable information products such as notebooks, personal digital assistants (PDAs), video cameras, and the like. Furthermore, LCDs are considered by some to have the potential to completely replace CRT (cathode ray tube) monitors and televisions.

Referring to FIG. 13, a typical transmissive LCD 13 includes a transmissive LCD panel 130, and a backlight module 140 adjacent to the transmissive LCD panel 130. The transmissive LCD panel 130 includes a color filter substrate assembly 131, a thin film transistor (TFT) substrate assembly 132 parallel to the color filter substrate assembly 131, and a liquid crystal layer 133 sandwiched between the two substrate assemblies 131, 132. The liquid crystal layer 133 includes a plurality of liquid crystal molecules (not labeled). The backlight module 140 is disposed below the TFT substrate assembly 132.

The color filter substrate assembly 131 includes a first transparent substrate 151, a color filter 152, and a common electrode 153 arranged in that order from top to bottom. The color filter 152 includes a plurality of red filters (R), a plurality of green filters (G), and a plurality of blue filters (B). The TFT substrate assembly 132 includes a second transparent substrate 161, and a pixel electrode 162 disposed on an inner surface of the second transparent substrate 161 that faces toward the color filter substrate assembly 131.

Light beams emitted from the backlight module 140 transmit through the TFT substrate assembly 132, the liquid crystal layer 133, and the color filter substrate assembly 131 in that sequence. Simultaneously, different voltages are applied to the common electrode 153 and the pixel electrode 162 respectively, so that an electrical field is generate therebetween. The electrical field induces the liquid crystal molecules to twist, thus allowing a certain quantity of light beams to pass through the transmissive LCD panel 130. Thereby, the LCD 13 displays desired images or text.

However, the LCD 13 needs the backlight module 140 to constantly provide light beams all the time. Therefore, the power consumption of the LCD 13 is relatively high.

What is needed, therefore, is a transflective LCD, which can use light beams from a backlight module to display in a dark environment, and also can use ambient light beams to display in a bright environment.

### SUMMARY

In one preferred embodiment, a transflective liquid crystal display includes a thin film transistor (TFT) substrate assembly, a color filter substrate assembly parallel to the TFT substrate assembly, a liquid crystal layer sandwiched between the TFT substrate assembly and the color filter substrate assembly, and a backlight module configured to provide light beams which transmit through the color filter substrate assembly, the liquid crystal layer, and the TFT substrate assembly. The color filter substrate assembly includes a transparent substrate, a transflective film, and a color filter. The transflective film is formed at an inner surface of the transparent substrate. The color filter is formed at an inner surface of the transflective film.

Other novel features and advantages will become more apparent from the following detailed description of preferred and exemplary embodiments when taken in conjunction with the accompanying drawings.

### BRIEF DESCRIPTION OF THE DRAWINGS

FIG. 1 is an exploded, side, cross-sectional view of part of a transflective LCD according to a first embodiment of the present invention, the transflective LCD including a transflective layer.

FIG. 2 is an enlarged, top plan view of part of the transflective film of FIG. 1.

FIG. 3 is similar to FIG. 2, but showing a corresponding view in the case of part of a transflective film of a transflective LCD according to a second embodiment of the present invention.

FIG. 4 is similar to FIG. 2, but showing a corresponding view in the case of part of a transflective film of a transflective LCD according to a third embodiment of the present invention.

FIG. 5 is similar to FIG. 2, but showing a corresponding view in the case of part of a transflective film of a transflective LCD according to a fourth embodiment of the present invention.

FIG. 6 is similar to FIG. 2, but showing a corresponding view in the case of part of a transflective film of a transflective LCD according to a fifth embodiment of the present invention.

FIG. 7 is an exploded, side, cross-sectional view of part of a transflective LCD according to a sixth embodiment of the present invention, the transflective LCD including a second transparent substrate partly covered by reflective material.

FIG. 8 is an enlarged, top plan view of part of the second transparent substrate of FIG. 7.

FIG. 9 is similar to FIG. 8, but showing a corresponding view in the case of part of a second transparent substrate of a transflective LCD according to a seventh embodiment of the present invention.

FIG. 10 is similar to FIG. 8, but showing a corresponding view in the case of part of a second transparent substrate of a transflective LCD according to an eighth embodiment of the present invention.

FIG. 11 is similar to FIG. 8, but showing a corresponding view in the case of part of a second transparent substrate of a transflective LCD according to a ninth embodiment of the present invention.

FIG. 12 is similar to FIG. 8, but showing a corresponding view in the case of part of a second transparent substrate of a transflective LCD according to a tenth embodiment of the present invention.

FIG. 13 is an exploded, side, cross-sectional view of a conventional transmissive LCD.

### DETAILED DESCRIPTION OF PREFERRED EMBODIMENTS

Reference will now be made to the drawings to describe preferred and exemplary embodiments in detail.

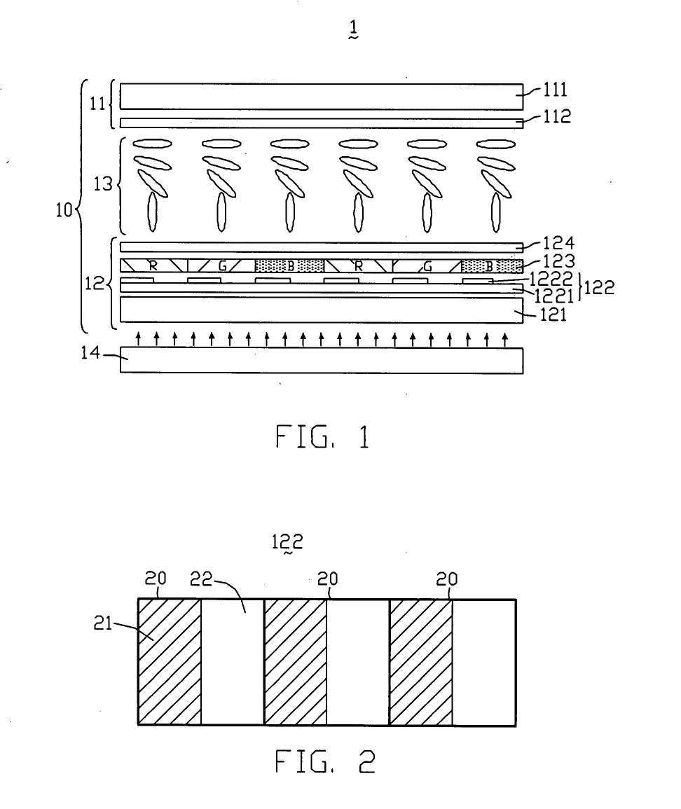

Referring to FIG. 1, part of a transflective liquid crystal display (LCD) 1 according to a first embodiment of the present invention is shown. The transflective LCD 1 includes an LCD panel 10, and a backlight module 14 configured to provide light beams to the LCD panel 10. The LCD panel 10 includes a thin film transistor (TFT) substrate assembly 11, a color filter substrate assembly 12 parallel to the TFT substrate assembly 11, and a liquid crystal layer 13 sandwiched between the two substrate assemblies 11, 12. The backlight module 14 is disposed below the color filter substrate assembly 12.

The TFT substrate assembly 11 includes a first transparent substrate 111, and a pixel electrode 112 formed on an inner surface of the first transparent substrate 111 that faces toward the color filter substrate assembly 12. The color filter substrate assembly 12 includes a second transparent substrate 121, a transflective film 122, a color filter 123, and a common electrode 124 arranged in that order from bottom to top.

The color filter 123 includes a plurality of red filter units (R), a plurality of green filter units (G), and a plurality of blue filter units (B) arranged in a matrix. The pixel electrode 112, the common electrode 124, and the liquid crystal layer 13 sandwiched between the pixel electrode 112 and the common electrode 124 cooperatively define a plurality of pixel units (not labeled). Each pixel unit corresponds to a respective filter unit of the color filter 123.

The transflective film 122 includes a transparent film 1221 and a discontinuous metal layer 1222. The metal layer 1222 is formed on an inner surface of the transparent film 1221. Referring also to FIG. 2, the transflective film 122 defines a plurality of transflective units 20. Each transflective unit 20 corresponds to a pixel unit, and is divided into two identically sized rectangular regions. One rectangular region corresponding to the metal layer 1222 is defined as a reflective region 21. The other rectangular region is defined as a transmissive region 22.

The transparent film 1221 can be made from polystyrene. The metal layer 1222 can be made from silver, aluminum, or neodymium. Gaps between portions of the metal layer 1222, corresponding to the transmissive regions 22, can be filled with suitable transparent material (not shown). Such transparent material can for example be polystyrene or another suitable passivation material. The first transparent substrate 111 and the second transparent substrate 121 can be made from glass or quartz. The common electrode 124 and the pixel electrode 112 can be made from indium tin oxide (ITO) or indium zinc oxide (IZO).

In a dark environment, because ambient light beams are insufficient, the transflective LCD 1 operates in a transmissive mode. Light beams emitted from the backlight module 14 transmit through the color filter substrate assembly 12, the liquid crystal layer 13, and the TFT substrate assembly 11 in sequence. Simultaneously, different voltages are applied to the common electrode 124 and the pixel electrode 112 respectively, so that an electrical field is generated therebetween. The electrical field induces liquid crystal molecules of the liquid crystal layer 13 to twist, thus allowing a certain quantity of light beams to pass through the LCD panel 10. Thereby, the transflective LCD 1 displays desired images or text.

In a bright environment, because ambient light beams are sufficient, the transflective LCD 1 operates in a reflective mode. The ambient light beams transmit through the TFT substrate assembly 11, the liquid crystal layer 13, the common electrode 124, and the color filter 123 in sequence, and then reach the transflective film 122. The ambient light beams are reflected by the metal layer 1222 of the transflective film 122. The reflected light beams transmit back through the color filter 123, the common electrode 124, the liquid crystal layer 13, and the TFT substrate assembly 11 in sequence, and exit the LCD panel 10. Simultaneously, different voltages are applied to the common electrode 124 and the pixel electrode 112 respectively, so that an electrical field is generated therebetween. The electrical field induces the liquid crystal molecules of the liquid crystal layer 13 to twist, thus allowing a certain quantity of light beams to pass through the LCD panel 10. Thereby, the LCD 1 displays desired images or text.

Compared with conventional LCDs, the transflective LCD 1 uses ambient light beams to display images when ambient light beams are sufficient. Therefore, power consuming of the transflective LCD 1 is reduced. Furthermore, the transflective film 122 is disposed in the color filter substrate assembly 12 that is adjacent to the backlight module 14. A manufacture process of the TFT substrate assembly 11 is simplified.

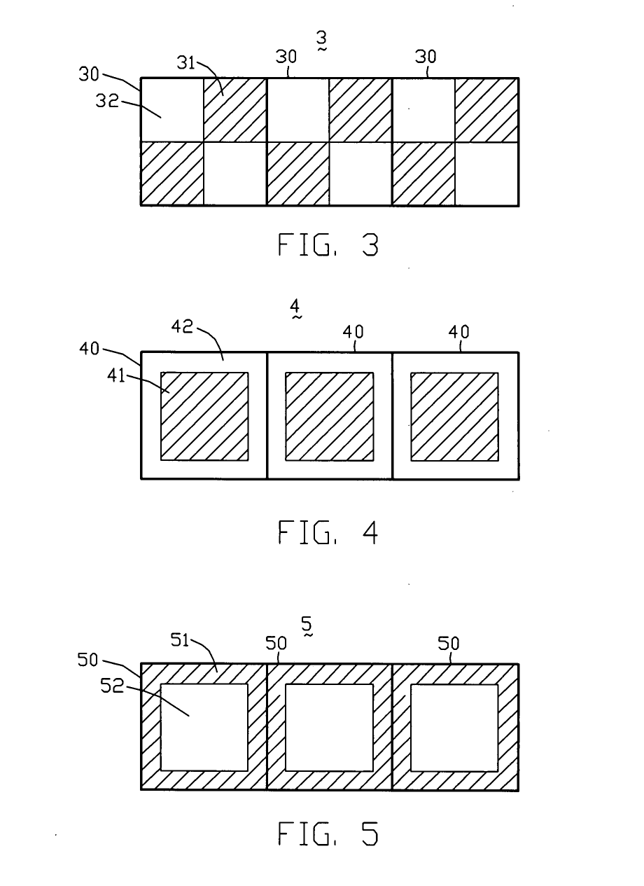

Referring to FIG. 3, a transflective LCD 3 according to a second embodiment of the present invention is similar to the transflective LCD 1. However, each of transflective units 30 of a transflective film is divided into four identically sized rectangular regions, which are arranged in a 2×2 matrix. Each of two rectangular regions that are diagonally opposite each other is defined as a reflective region 31. Each of the other two rectangular regions that are diagonally opposite each other is defined as a transmissive region 32.

Referring to FIG. 4, a transflective LCD 4 according to a third embodiment of the present invention is similar to the transflective LCD 1. However, a central rectangular part of each of transflective units 40 of a transflective film is defined as a reflective region 41. A peripheral region surrounding the reflective region 41 of the transflective unit 40 is defined as a transmissive region 42.

Referring to FIG. 5, a transflective LCD 5 according to a fourth embodiment of the present invention is similar to the transflective LCD 1. However, a central rectangular part of each of transflective units 50 of a transflective film is defined as a transmissive region 52. A peripheral region surrounding the transmissive region 52 of the transflective unit 50 is defined as a reflective region 51.

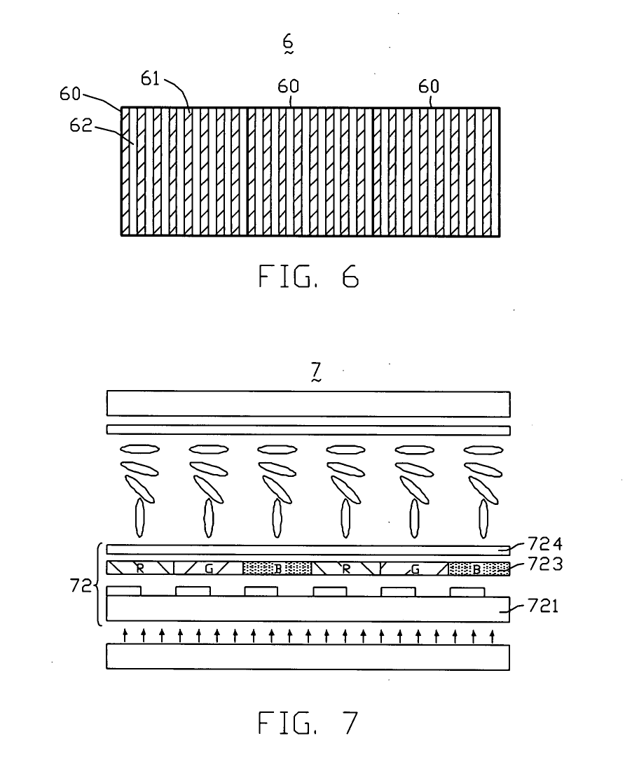

Referring to FIG. 6, a transflective LCD 6 according to a fifth embodiment of the present invention is similar to the transflective LCD 1. However, each of transflective units 60 of a transflective film is divided into a plurality of identically sized parallel strip-shaped regions. The strip-shaped regions are defined as reflective regions 61 and transmissive regions 62 alternately arranged.

Referring to FIG. 7, a transflective LCD 7 according to a sixth embodiment of the present invention is similar to the transflective LCD 1. However, a color filter substrate assembly 72 includes a second transparent substrate 721, a color filter 723, and a common electrode 724 arranged in that order from bottom to top. An inner surface of the second transparent substrate 721 is partly covered with reflective material.

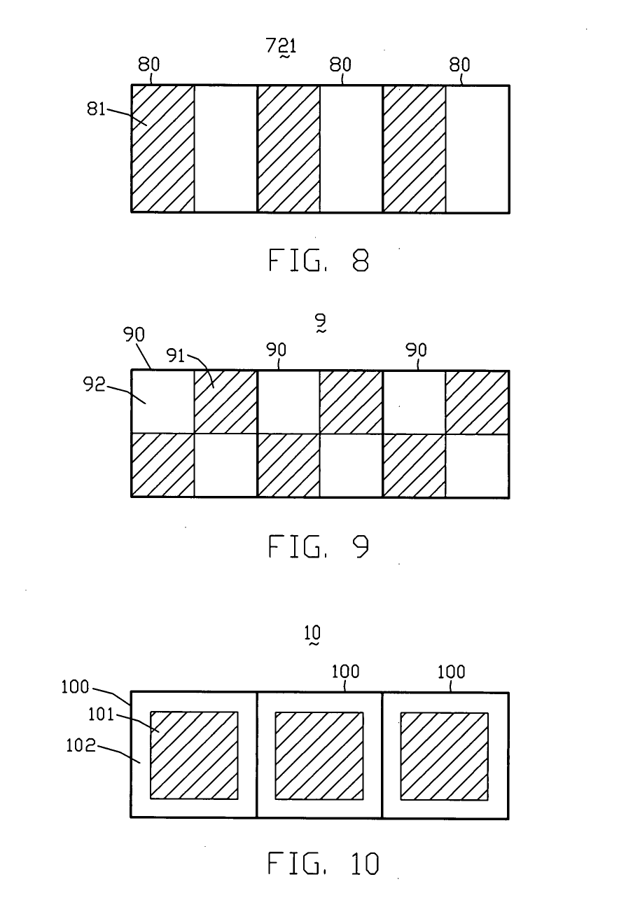

Referring also to FIG. 8, the second transparent substrate 721 defines a plurality of transflective units 80. Each transflective unit 80 corresponds to a respective filter unit of the color filter 723. Each transflective unit 80 is divided into two identically sized rectangular regions. One rectangular region is defined as a reflective region 81, and the reflective region 81 is covered by reflective material. The other rectangular region is defined as a transmissive region 82. The reflective material can be made from a metal with a high reflective index, such as silver, aluminum, or neodymium. Gaps between portions of the reflective material, corresponding to the transmissive regions 82, can be filled with suitable transparent material (not shown). Such transparent material can for example be polystyrene or another suitable passivation material.

Referring to FIG. 9, a transflective LCD 9 according to a seventh embodiment of the present invention is similar to the transflective LCD 7. However, each of transflective units 90 of a second transparent substrate is divided into four identically sized rectangular regions, which are arranged in a 2×2 matrix. Each of two rectangular regions that are diagonally opposite each other is defined as a reflective region 91. Each of the other two rectangular regions that are diagonally opposite each other is defined as a transmissive region 92. The reflective regions 91 are covered by reflective material. The reflective material can be made from a metal with a high reflective index, such as silver, aluminum, or neodymium.

Referring to FIG. 10, a transflective LCD 10 according to an eighth embodiment of the present invention is similar to the transflective LCD 7. However, a central rectangular part of each of transflective units 100 of a second transparent substrate is defined as a reflective region 101. A peripheral region surrounding the reflective region 101 of the transflective unit 100 is defined as a transmissive region 102. The reflective region 101 is covered by reflective material. The reflective material can be made from a metal with a high reflective index, such as silver, aluminum, or neodymium.

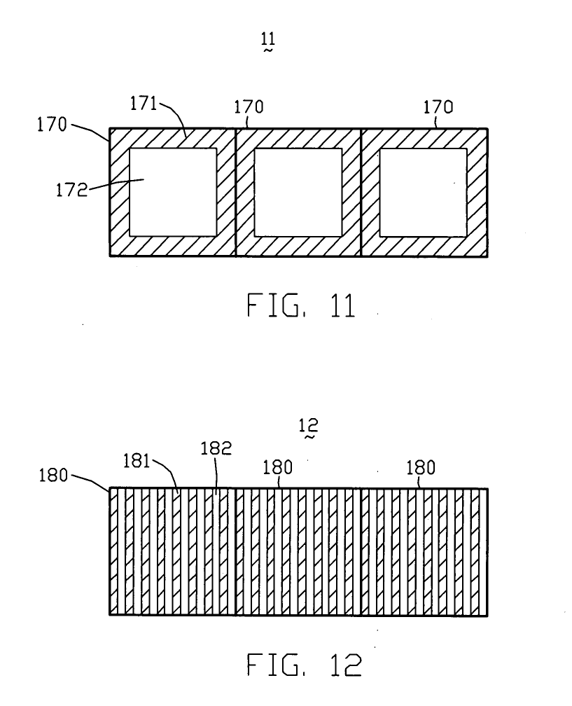

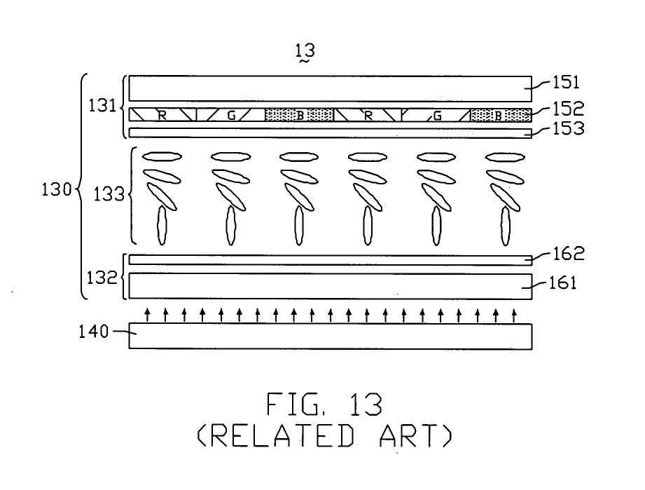

Referring to FIG. 11, a transflective LCD 11 according to a ninth embodiment of the present invention is similar to the transflective LCD 7. However, a central rectangular part of each of transflective units 170 of a second transparent substrate is defined as a transmissive region 172. A peripheral region surrounding the transmissive region 172 of the transflective unit 170 is defined as a reflective region 171. The reflective region 171 is covered by reflective material. The reflective material can be made from a metal with a high reflective index, such as silver, aluminum, or neodymium.

Referring to FIG. 12, a transflective LCD 12 according to a tenth embodiment of the present invention is similar to the transflective LCD 7. However, each of transflective units 180 of a second transparent substrate is divided into a plurality of identically sized strip-shaped regions. The strip-shaped regions are defined as transmissive regions 182 and reflective regions 181 alternately arranged. The reflective regions 181 are covered by reflective material. The reflective material can be made from a metal with a high reflective index, such as silver, aluminum, or neodymium.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A transflective liquid crystal display device, comprising:
a thin film transistor (TFT) substrate assembly;
a color filter substrate assembly parallel to the TFT substrate assembly, the color filter substrate assembly comprising:
a transparent substrate;
a transflective film formed at an inner surface of the transparent substrate; and
a color filter formed at an inner surface of the transflective film;
a liquid crystal layer sandwiched between the TFT substrate assembly and the color filter substrate assembly; and
a backlight module configured to provide light beams which transmit through the color filter substrate assembly, the liquid crystal layer, and the TFT substrate assembly in sequence.

2. The transflective liquid crystal display as claimed in claim 1, wherein the transflective film comprises a plurality of transflective units, and each transflective unit defines a reflective region and a transmissive region.

3. The transflective liquid crystal display as claimed in claim 2, wherein the transflective film comprises a transparent film and a discontinuous metal layer, and the metal layer corresponds to the reflective regions.

4. The transflective liquid crystal display as claimed in claim 3, wherein each transflective unit is divided into two identically sized rectangular regions, one rectangular region is defined as the reflective region, and the other rectangular region is defined as the transmissive region.

5. The transflective liquid crystal display as claimed in claim 3, wherein each transflective unit is divided into four identically sized rectangular regions which are arranged in a 2×2 matrix, two diagonally opposite of the rectangular regions are cooperatively defined as the reflective region, and the other two diagonally opposite of the rectangular regions are cooperatively defined as the transmissive region.

6. The transflective liquid crystal display as claimed in claim 3, wherein a central rectangular part of each transflective unit is defined as the reflective region, and a peripheral region of the transflective unit surrounding the reflective region is defined as the transmissive region.

7. The transflective liquid crystal display as claimed in claim 3, wherein a central rectangular part of each transflective unit is defined as the transmissive region, and a peripheral region of the transflective unit surrounding the reflective region is defined as the reflective region.

8. The transflective liquid crystal display as claimed in claim 3, wherein each transflective unit is divided into a plurality of identically sized parallel strip-shaped regions, the strip-shaped regions are defined as first strip-shaped regions and second strip-shaped regions alternately arranged, the first strip-shaped regions are cooperatively defined as the reflective region, and the second strip-shaped regions are cooperatively defined as the transmissive region.

9. The transflective liquid crystal display as claimed in claim 3, wherein the color filter comprises a plurality of red filter units, a plurality of green filter units, and a plurality of blue filter units which are arranged in a matrix, and each filter unit corresponds to a respective transflective unit.

10. The transflective liquid crystal display as claimed in claim 3, wherein the metal layer is made from at least one material selected from the group consisting of silver, aluminum, and neodymium.

11. The transflective liquid crystal display as claimed in claim 3, wherein the transparent film is made from polystyrene.

12. A transflective liquid crystal display comprising:
a thin film transistor (TFT) substrate assembly;
a color filter substrate assembly parallel to the TFT substrate assembly, the color filter substrate assembly comprising:
a transparent substrate which is partly covered by reflective material at an inner side thereof; and
a color filter formed at an inner side of the reflective material;
a liquid crystal layer sandwiched between the TFT substrate assembly and the color filter substrate assembly; and
a backlight module configured to provide light beams which transmit through the color filter substrate assembly, the liquid crystal layer, and the TFT substrate assembly in sequence.

13. The transflective liquid crystal display as claimed in claim 12, wherein the transparent substrate defines a plurality of transflective units, and each transflective unit defines a reflective region and a transmissive region, the reflective region being covered by the reflective material.

14. The transflective liquid crystal display as claimed in claim 13, wherein each transflective unit is divided into two identically sized rectangular regions, one rectangular region is defined as the reflective region, and the other rectangular region is defined as the transmissive region.

15. The transflective liquid crystal display as claimed in claim 13, wherein each transflective unit is divided into four identically sized rectangular regions which are arranged in a 2×2 matrix, two diagonally opposite of the rectangular regions are cooperatively defined as the reflective region, and the other two diagonally opposite of the rectangular regions are cooperatively defined as the transmissive region.

16. The transflective liquid crystal display as claimed in claim 13, wherein a central rectangular part of each transflective unit is defined as the reflective region, and a peripheral region of the transflective unit surrounding the reflective region is defined as the transmissive region.

17. The transflective liquid crystal display as claimed in claim 13, wherein a central rectangular part of each transflective unit is defined as the transmissive region, and a peripheral region of the transflective unit surrounding the reflective region is defined as the reflective region.

18. The transflective liquid crystal display as claimed in claim 13, wherein each transflective unit is divided into a plurality of identically sized parallel strip-shaped regions, the strip-shaped regions are defined as first strip-shaped regions and second strip-shaped regions alternately arranged, the first strip-shaped regions are cooperatively defined as the reflective region, and the second strip-shaped regions are cooperatively defined as the transmissive region.

19. The transflective liquid crystal display as claimed in claim 13, wherein the color filter comprises a plurality of red filter units, a plurality of green filter units, and a plurality of blue filter units arranged in a matrix, and each filter unit corresponds to a respective transflective unit of the transparent substrate.

20. The transflective liquid crystal display as claimed in claim 13, wherein the reflective material includes at least one of silver, aluminum, and neodymium.
